(19) United States
(12) Patent Application Publication
(10) Pub. No.: US 2016/0139700 A1
(43) Pub. Date: May 19, 2016

(54) CAPACITIVE TOUCH ARRAY SUBSTRATE, TOUCH DISPLAY SCREEN AND DRIVING METHOD THEREOF

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Lei WANG, Beijing (CN); Xue DONG, Beijing (CN); Hailin XUE, Beijing (CN); Chunlei WANG, Beijing (CN)

(21) Appl. No.: 14/344,253

(22) PCT Filed: Jun. 20, 2013
(86) PCT No.: PCT/CN2013/077588

§ 371 Date: Mar. 11, 2014

(30) Foreign Application Priority Data
Apr. 16, 2013 (CN) 201310131875.0

(51) Int. Cl. G06F 3/044

(52) U.S. Cl. CPC G06F 3/044; G06F 2203/04103

(57) ABSTRACT

A capacitive touch array substrate, a touch display screen and a driving method thereof are disclosed to alleviate display abnormality caused by driving voltage imbalance between the parts of the common electrode. The capacitive touch array substrate includes an array substrate including a common electrode including a first part connected with a common voltage driving circuit and a second part including a plurality of touch driving electrodes, and the first part of the common electrode is connected with the touch driving electrodes via switching transistors.

### TECHNICAL FIELD

Embodiments of the present invention relate to a capacitive touch array substrate, a touch display screen and a driving method thereof.

### BACKGROUND

Touch display screens are undergoing a very fast development. At present, main stream products adopt the add-on touch panel structure design. However, for conventional add-on touch panels, the overall product is bulky and costs are high. With the consumers' demands for thin displays, in-cell liquid crystal screens have become one important development direction in the touch display field.

However, since electrodes need to be added within a liquid crystal cell for an in-cell mode, display effect will be affected more or less. In a structure of a conventional in-cell touch display screen, both driving electrodes and sensing electrodes are designed inside the liquid crystal cell; sensing electrodes are provided on the inner sides of the substrates assembled to form the cell, that is, at locations corresponding to the black matrix, and driving electrodes are formed of divided parts of common electrodes, that is, in the display area (AA area) of the display screen. Common electrodes are divided into two parts, one part of which are completely identical with the conventional common electrodes and connected with a common voltage driving circuit, and the other part of the common electrodes is driven in a time-division manner, during a display stage, these electrodes are applied with a common voltage to function as the conventional common electrodes, and during a touch stage are applied with a touch driving voltage (square wave, sine wave etc.) to function as touch driving electrodes. Although this kind of in-cell structure can realize touch display function, in fact the inventors has found that the display driving circuits and the touch driving circuits of a conventional touch display screen are mutually independent, and the difference between the display driving circuits and the touch driving circuits or the voltage boosting difference between the display driving circuit and the touch driving circuit themselves can not guarantee consistent potentials of the two parts of common electrodes among display stages (that is, guarantee that the common voltage from the display driving circuits and the common voltage from the touch driving circuits are completely equal). If the two potentials are inconsistent, the electric fields for driving the liquid crystal vary, thereby influencing the transmittance of the touch display screen and causing display non-uniformity as a whole.

### SUMMARY

Embodiments of the present invention provide a capacitive touch array substrate, a touch display screen and a driving method thereof that can increase transmittance, alleviate display abnormality caused by driving voltage imbalance between the parts of the common electrodes.

In order to address the above-mentioned technology problems, embodiments of the present invention adopt the following technical proposal.

An embodiment of the present invention provides a capacitive touch array substrate comprising a common electrode comprising a first part and a second part independent of each other, the first part being connected with a common voltage driving circuit and the second part comprising a plurality of touch driving electrodes, the first part of the common electrode is connected with the touch driving electrodes via switching transistors.

Preferably, for example, the first part of the common electrode is connected with a common voltage driving circuit via common electrode leads, the touch driving electrodes are connected with a touch driving circuit via touch driving leads, and the touch driving electrodes are connected with the switching transistors via touch driving leads.

Optionally, for example, the switching transistors are thin film transistors, source electrodes of the thin film transistors are connected with the touch driving leads, drain electrodes of the thin film transistors are connected with the common electrode leads, and gate electrodes of the thin film transistors are configured to input first signals.

Preferably, for example, the gate electrodes of the thin film transistors connected with one of the touch driving leads are connected with the gate lines in the region corresponding to this touch driving lead in one-to-one correspondence, and the first signals are signals received from the gate lines.

An embodiment of the present invention provides a touch display screen including the above-mentioned capacitive touch array substrate.

Correspondingly, an embodiment of the present invention further provides a driving method for a touch display screen comprising: in a display stage, turning on switching transistors, with first signals, to conduct a first part and a second part of a common electrode; and in a touch sensing stage, turning off the switching transistors, by first signals, to disconnect the first part and the second part of the common electrode.

In a preferable implementation, for example, the first signals are gate scanning signals, in the display stage, the first signals turning on the switching transistors to conduct the first part and the second part of the common electrode comprises: in the display stage, in a process in which the gate scanning signals turn on a row of gate line to charge pixel electrodes in this row, a high level output by this row of gate line turns on the switching transistor connected with this row of gate line to conduct the first part and the second part of the common electrode; when the gate scanning signals turn off this row of gate line, a high level output by a next row of gate line turns on a switching transistor connected with the next row of gate line to conduct the first part and the second part of the common electrode;

In the touch sensing stage, turning off the switching transistors, by first signals, to disconnect the first part and the second part of the common electrode comprises: in the touch sensing stage, the gate scanning signals turn off the first to the last rows of gate lines, all gate lines output low levels, all of the switching transistors connected with the gate lines are turned off, and the first part and the second part of the common electrode are disconnected from each other.

The switching transistors may be thin film transistors.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of a capacitive touch array substrate;

FIG. 2 is a distribution schematic diagram of a common electrode in a display area of the capacitive touch array substrate illustrated in FIG. 1;

FIG. 3 is a structural representation of the first capacitive touch array substrate provided in embodiment II of the present invention;

FIG. 4 is a structural representation of another capacitive touch array substrate provided in embodiment III of the present invention; and

FIG. 5 is a flow chart of the driving method for a touch display screen provided in embodiment IV of the present invention.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” and the like, which are used in the description and the claims of the present application for invention, are not intended to indicate any sequence, amount or importance, but distinguish various components. Also, the terms such as “a,” “an,” and the like are not intended to limit the amount, but indicate the existence of at lease one. The terms “comprises,” “comprising,” “includes,” “including,” and the like are intended to specify that the elements or the objects stated before these terms encompass the elements or the objects and equivalents thereof listed after these terms, but do not preclude the other elements or objects. The phrases “connect”, “connected”, and the like are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

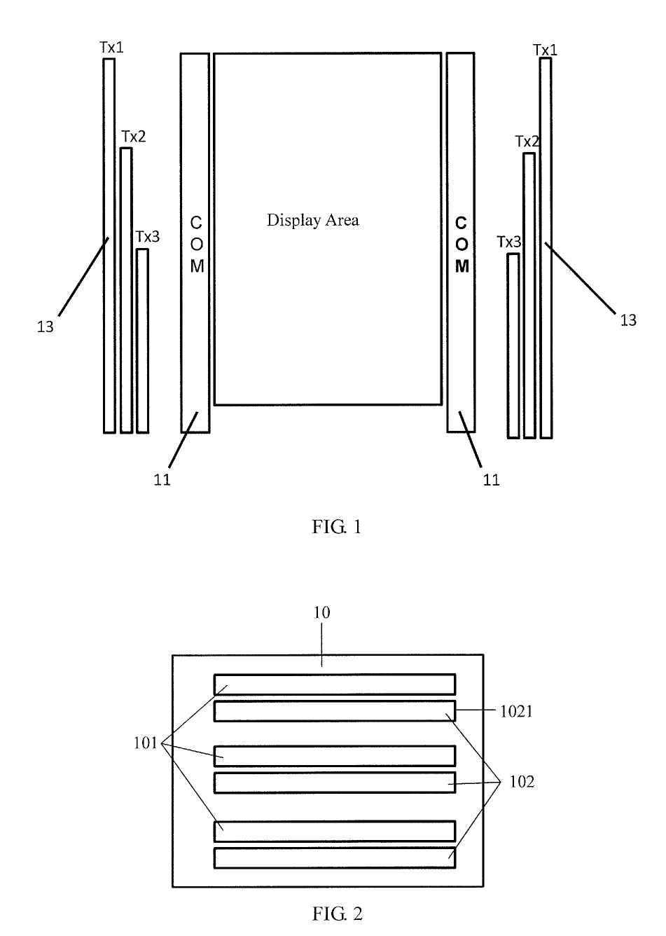

FIGS. 1 and 2 illustrate an in-cell capacitive touch array substrate including common electrodes 10 each including a first part 101 and a second part 102 independent of each other, the first part 101 is connected with a common voltage driving circuit (not illustrated in the figure) via common electrode leads 11, and the second part 102 includes a plurality of touch driving electrodes 1021. The touch driving electrodes are connected with a touch driving circuit (not illustrated in the figure) via touch driving leads 13.

For the capacitive touch array substrate illustrated in FIGS. 1 and 2, an embodiment of the present invention provides a method for improving display effect of a touch display screen including the capacitive touch array substrate based on the principle as follows:

In the display stage, the first part 101 and the second part 102 of the common electrode 10 are conducted with each other; and

In the touch sensing stage, the first part 101 and the second part 102 of the common electrode 10 are disconnected from each other.

The conducting between the first part 101 and the second part 102 of the common electrode 10 described in the embodiment of the present invention means that the first part 101 and the second part 102 are electrically connected with zero resistance directly or indirectly so as to keep the potentials of them (the first part 101 and the second part 102) consistent. Since the electric fields for driving liquid crystal to rotate generated at the first part 101 and the second part 102 of the common electrode 10 have no difference therebetween, display abnormality caused by driving voltage imbalance of the parts of the common electrodes can be avoided, thereby increasing the transmittance of the touch display screen and improving display effect.

Particularly, the conducting/disconnecting between the first part and the second part of the common electrode may be implemented by the on/off operations of a switching transistor, and the switching transistor may be disposed in a display area of the capacitive touch array substrate, or may be disposed in a non-display area at edges of the capacitive touch array substrate (the preferable implementations are described in for example embodiments I and II).

### Embodiment I

The first embodiment of the present invention provides a capacitive touch array substrate including a common electrode including a first part and a second part independent of each other, the first part is connected with a common voltage driving circuit via common electrode leads, the second part includes a plurality of touch driving electrodes that are connected with a touch driving circuit, and the first part of the common electrode is connected with touch driving electrodes via switching transistors.

The switching transistor described in embodiment I comprises two connect ends and one control end, and the control end is used for inputting control signals for controlling whether the two connect ends are connected or not. Of the two connect ends of the switching transistor described in embodiment I, one connect end is connected with the first part of a common electrode, and the other connect end is connected with the second part (touch driving electrodes) of the common electrode. The control end is input with first signals.

In the display stage, the first signals described in the embodiment I of the present invention turn on the switching transistors to make the first part and the second part of the common electrode connected, that is, the first part and the second part are electrically connected with zero resistance directly or indirectly to keep the potentials of them (the first part and the second part) consistent. Since the electric fields for driving liquid crystal to rotate generated at the first part and the second part of the common electrode have no difference therebetween, display abnormality caused by driving voltage imbalance between the parts of the common electrodes can be avoided, thereby increasing the transmittance of the touch display screen including the capacitive touch array substrate and improving the display effect. In the touch sensing stage, the first signals turn off the switching transistors to disconnect the first part and the second part of the common electrode, and the second part of the common electrode receive touch signals to realize touch function.

### Embodiment II

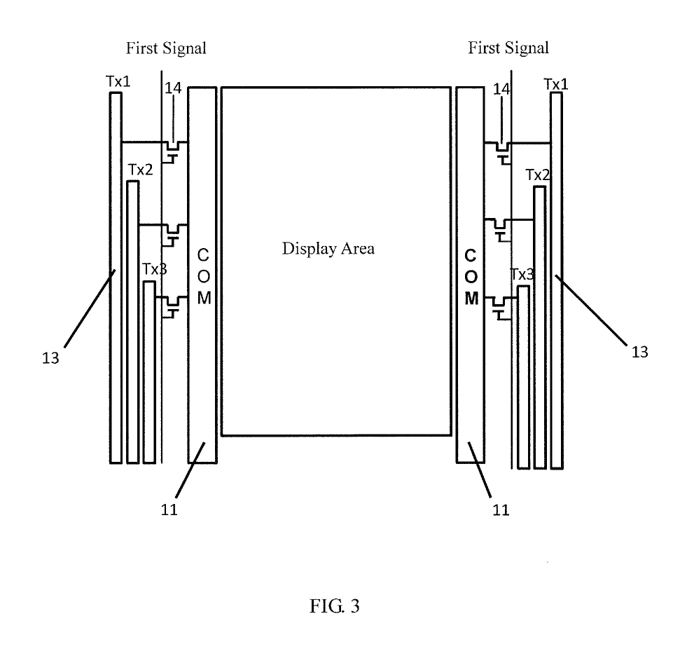

The second embodiment of the present invention provides a capacitive touch array substrate. As illustrated in FIGS. 2 and 3, the capacitive touch array substrate includes a common electrode 10 including a first part 101 and a second part independent of each other, the first part 10 is connected with a common voltage driving circuit (not illustrated) via common electrode leads 11, the second part 102 includes a plurality of touch driving electrodes that are connected with a touch driving circuit (not illustrated) via touch driving leads 13, and the touch driving electrodes are connected with the switching transistors via the touch driving leads 13.

Particularly, the second part 102 includes a plurality of touch driving electrodes 1021 each of which is connected with a touch driver circuit (not illustrated in the figure) via a touch driving lead 13 at an edge of the substrate. Each of the touch driving leads 13 is connected with a switching transistor.

As illustrated in FIG. 3, preferably, for example, the switching transistors described in this embodiment may be thin film transistors 14. Each touch driving lead 13 is connected with a common electrode lead 11 via a thin film transistor 14, the source electrode of the thin film transistor 14 is connected with the touch driving lead 13, the drain electrode is connected with the common electrode lead 11, and the gate electrode is configured for input of first signals.

Particularly, for example, in the display stage, the first signals output a high level to turn on the thin film transistor 14, the touch driving leads 13 are conducted with the common electrode leads 11, making the first part 101 and the second part 102 of the common electrode 10 conducted with each other; in the touch sensing stage, the first signals outputs a low level to turn off the thin film transistors 14, and the touch driving leads 13 are disconnected from the common electrode leads 11, making the first part 101 and the second part 102 of the common electrode 10 disconnected from each other, and the variation of the touch driving potential on the second part 102 will not affect the common voltage. The first signals may be of existing control signals such as gate scanning signals, or control signals satisfying the above-mentioned requirements may be those generated further from the clock signals.

For the capacitive touch array substrate provided in embodiment II of the present invention, in the display stage, the first part and the second part of the common electrode are conducted with each other; in the touch sensing stage, the first part and the second part of the common electrode are disconnected from each other to avoid display abnormality caused by driving voltage imbalance of the parts of the common electrodes, hence increasing the transmittance of touch display screen including the capacitive touch array substrate and improving the display effect.

### Embodiment III

The third embodiment of the present invention further provides another capacitive touch array substrate that is different from the above-mentioned capacitive touch array substrates in that the number of switching transistors is the same as the number of gate lines in regions corresponding to the touch driving electrodes.

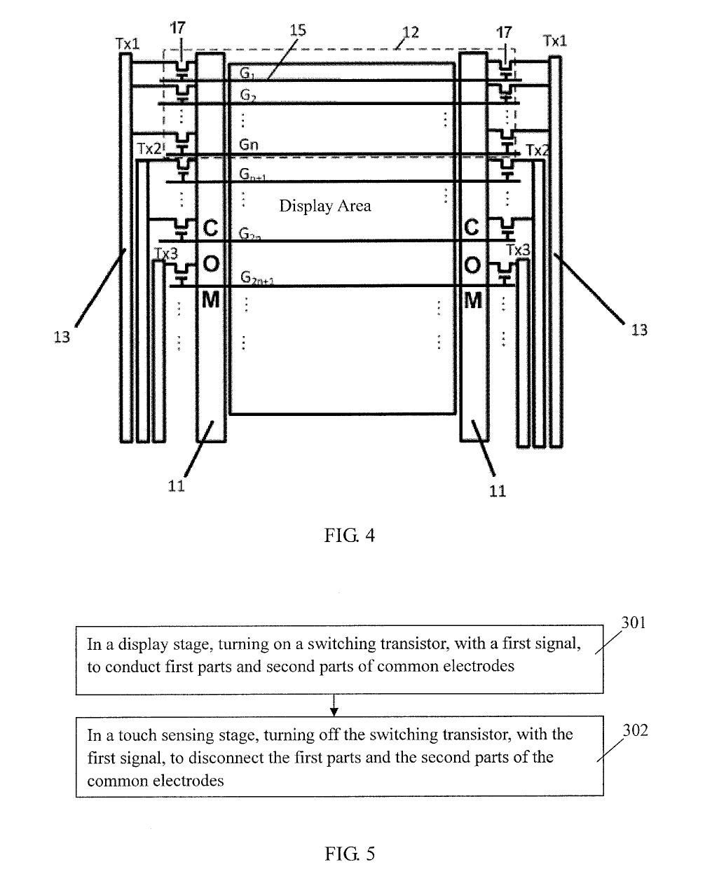

As illustrated in FIG. 4, a switching transistor is a thin film transistor 17 of which the source electrode is connected with a touch driving lead 13 and the drain electrode is connected with a common electrode lead 11, and the gate electrodes of all the thin film transistors 17 are connected with the gate lines 15 in regions corresponding to touch driving electrodes in one-to-one correspondence, and the first signals are signals received by gate lines.

The capacitive touch array substrate illustrated in FIG. 4 will be descried in detail below. The second part 102 includes a plurality of touch driving electrodes, and each touch driving electrode is connected with a touch driving lead 13 at an edge of the substrate. The number of thin film transistors 14 connected with the same touch driving lead 13 equals to the number of gate lines 15 in a region 12 corresponding to this touch driving electrode; the gate electrodes of the thin film transistors 17 are connected with the gate lines 15 in a region 12 corresponding to the touch driving electrode (namely the broken line box region in the figure) in one-to-one correspondence.

This third embodiment utilizes the gate scanning signals to control on/off operations of the thin film transistors 17, that is, the first signals are generated from the gate scanning signals.

Particularly, for example, as illustrated in FIG. 4, the common electrode in the region in which pixels controlled by the 1st˜nth rows of gate lines continuously arranged are located serves as the first touch driving electrode, and in the edge non-display area on the capacitive touch array substrate the first touch driving electrode is connected with the first touch driving lead TX1; the common electrode in the region in which pixels controlled by the n+1th˜2nth rows of gate lines continuously arranged are located serves as the second touch driving electrode, and in the edge non-display area on the capacitive touch array substrate the second touch driving electrode is connected with the second touch driving lead TX2; the common electrode in the region in which pixels controlled by the 2n+1th˜3nth rows of gate lines continuously arranged are located serves as the third touch driving electrode, and is connected with the third touch driving lead TX3; and so on, the common electrode in the region in which pixels controlled by the kn+1th˜(k+1)nth rows of gate lines continuously arranged are located serves as the kth touch driving electrode, and is connected with the kth touch driving lead TXk. Here, “n” is a non-zero natural number of a specific value dependent on the size, resolution and design of the entire display screen. For example, based on the industry standards, the width of the display area from G1˜Gn is generally 5 mm. Here, “k” is a non-zero natural number, and “k” is generally the total number of touch driving electrodes of the capacitive touch array substrate with a specific value depending on the size, resolution and design of the capacitive touch array substrate.

In the embodiment III of the present invention, a thin film transistor 17 is disposed between any touch driving lead 13 and a common electrode lead 11 and the specific number of the thin film transistors 17 equals to the number of the gate lines 15 in the region corresponding to the touch driving electrode. Specific description will be given below with the first touch driving lead TX1 as an example: n thin film transistors 17 are provided between the first touch driving lead TX1 and the common electrode lead 11, the source electrodes of these thin film transistors 17 are all connected with the touch driving lead TX1, the drain electrodes are all connected with the common electrode lead 11, and the gate electrodes of these thin film transistors 17 are connected with the 1st˜nth rows of gate lines (G1˜Gn) in one-to-one correspondence respectively, as illustrated in FIG. 4.

Thin film transistors 17 are also provided between the remaining touch driving leads (TX2˜TXk) and the common electrode lead 11, and the specific connecting mode is similar except that n thin film transistors 17 are provided between the touch driving lead TX2 and the common electrode lead 11, of which the gate electrodes are connected with the n+1th˜2nth rows of gate lines (Gn+1˜G2n) in one-to-one correspondence respectively; thin film transistors 17 are provided between the touch driving lead TXk and the common electrode lead 11, of which the gate electrodes are connected with the kn+1 th˜(k+1)nth of gate lines (Gkn+1˜G(k+1)n) in one-to-one correspondence respectively, which is not described any more here.

It is to be noted that the touch driving leads may be connected with all gate lines in the regions corresponding to the touch driving electrodes, or may be connected with selected region(s) or several gate lines, which is not limited here; each touch driving electrode may be provided with a touch driving lead on only one side, unnecessarily on both sides of the edge of the capacitive touch array substrate.

Based on the above-mentioned structure description, those skilled in the art can understand the following. In the display stage, the gate scanning signals turn on the gate lines line by line, when the data lines apply driving voltages to pixel electrodes, the high level output by the gate lines turns on the thin film transistors 14 between the touch driving leads 13 and the common electrode leads 11 at the same time, conducting the first part 101 and the second part 102 of the common electrode 10, ensuring potentials of them consistent, hence alleviating display abnormality caused by driving voltage imbalance between the parts of the common electrodes, increasing the transmittance of the touch display screen including the capacitive touch array substrate and improving the display effect. In the touch sensing stage, all gate lines output a low level signal, all thin film transistors are in an off-state, and the first part 101 and the second part 102 of the common electrode are disconnected from each other. At this time, the second part 102 of the common electrode loads a driving voltage and cooperate with the sensing lines to implement touch sensing function. Since at this time the first part 101 and the second part 102 are disconnected from each other, the potential of the first part is not affected.

Furthermore, optionally the capacitive touch array substrate described in this embodiment III may adopt periphery routing mode, in which touch driving leads 13 are routed at an outer side of the common electrode lead 11.

Optionally, the thin film transistors, as described in the embodiment III, are connected between the touch driving leads 13 and the common electrode leads 11 and located in the non-display area at the edge of the substrate. In manufacturing, the thin film transistors may be formed at the same time of the driving thin film transistors in the display area.

For the capacitive touch array substrate described in the third embodiment, the gate scanning signals are used to control the on/off operations of the thin film transistors such that in the display stage, the first part and the second part of the common electrode are conducted with each other; in the touch sensing stage, the first part and the second part of the common electrode are disconnected from each other to avoid display abnormality caused by driving voltage imbalance between the parts of the common electrodes, hence increasing the transmittance of touch display screen including the capacitive touch array substrate and improving the display effect.

Furthermore, an embodiment of the present invention further provides a touch display screen including the capacitive touch array substrate described in any of the above-mentioned embodiments, and further including a cell-assembling substrate provided with sensing electrodes. Optionally, the sensing electrodes may be disposed on the inner sides of the cell-assembling substrate and at locations corresponding to the black matrix.

Sensing electrodes and touch driving electrodes are intersected with each other. When touch driving electrodes are driven, sensing electrodes generate inductive capacitance. When a finger (or other object) approaches or touches the screen, capacitance between the touch driving electrode and the sensing electrode intersecting around the touch point will be influenced and the location of the touch point may be identified by detecting capacitance variation of the sensing electrodes.

### Embodiment IV

The fourth embodiment of the present invention further provides a driving method for a touch display screen as illustrated in FIGS. 4 and 5, including:

301. In a display stage, turning on a switching transistor, with a first signal, to conduct first part and second part of a common electrode;

302. In a touch sensing stage, turning off the switching transistor, with the first signal, to disconnect the first part and the second part of the common electrode.

Particularly, for example, the switching transistor is a thin film transistor, and the first signal may be a gate scanning signal, and the method may include the following.

In the display stage, in the process in which a gate scanning signal turns on the first row of gate line G1 to charge the first row of pixel electrode, the high level output by the first row of gate line G1 turns on the thin film transistor 17 connected with the first row of gate line G1 to conduct the first part and the second part of the common electrode; when the gate scanning signal turns off the first row of gate line G1 and turns on the next row of gate line G2, the high level output by the next row of gate line G2 turns on the thin film transistor 17 connected with this row of gate line to conduct the first part and the second part of the common electrode, and so on, until the last row of gate line, the display stage is over.

In the touch sensing stage, the gate scanning signal turns off the first to the last rows of gate lines, all gate lines output a low level, all thin film transistors connected with the gate lines are turned off, and the first part and the second part of the common electrode are disconnected from each other.

For the driving method for touch display screen described in this embodiment, gate scanning signals are used to control the on/off operations of the thin film transistors such that in the display stage, the first part and the second part of the common electrode are conducted with each other; in the touch sensing stage, the first part and the second part of the common electrode are disconnected from each other to alleviate display abnormality caused by driving voltage imbalance between the parts of the common electrodes, hence increasing the transmittance of touch display screen and improving the display effect.

What have been described are only specific implementations of embodiments of the present invention, the protection scope of the present invention is not limited thereto. Variations or substitutions easily occur to those skilled in the art in the technical scope disclosed by the present invention, which should be encompassed in the protection scope of the present invention. Therefore, the protection scope of the present invention should be based on the protection scope of the claims.

1. A capacitive touch array substrate comprising a common electrode comprising a first part and a second part, the first part being connected with a common voltage driving circuit and the second part comprising a plurality of touch driving electrodes, wherein the first part of the common electrode is connected with the touch driving electrodes via switching transistors.

2. The capacitive touch array substrate of claim 1, wherein the first part of the common electrode is connected with a common voltage driving circuit via common electrode leads, the touch driving electrodes are connected with a touch driving circuit via touch driving leads and the touch driving electrodes are connected with the switching transistors via touch driving leads.

3. The capacitive touch array substrate of claim 2, wherein a number of the switching transistors connected with one of the touch driving leads is the same as a number of gate lines in a region corresponding to this touch driving lead for the touch driving electrodes.

4. The capacitive touch array substrate of claim 2, wherein the switching transistors are thin film transistors, source electrodes of the thin film transistors are connected with the touch driving leads, drain electrodes of the thin film transistors are connected with the common electrode leads, and gate electrodes of the thin film transistors are configured to input first signals.

5. The capacitive touch array substrate of claim 4, wherein the gate electrodes of the thin film transistors connected with one of the touch driving leads are connected with the gate lines in the region corresponding to this touch driving lead for the touch driving electrodes in one-to-one correspondence, and the first signals are signals received from the gate lines.

6. A touch display screen comprising the capacitive touch array substrate of claim 1.

7. A driving method for a touch display screen, comprising:
in a display stage, turning on switching transistors, with first signals, to conduct a first part and a second part of common electrode; and
in a touch sensing stage, turning off the switching transistors, with the first signals, to disconnect the first part and the second part of the common electrode.

8. The driving method of claim 7, wherein the first signals are gate scanning signals,
in the display stage, the first signals turning on the switching transistors to conduct the first part and the second part of the common electrode comprises:
in the display stage, in a process in which the gate scanning signals turn on a row of gate line to charge pixel electrodes in this row, a high level output by this row of gate line turns on the switching transistor connected with this row of gate line to conduct the first part and the second part of the common electrode; when the gate scanning signals turn off this row of gate line, a high level output by a next row of gate line turns on a switching transistor connected with the next row of gate line to conduct the first part and the second part of the common electrode;
in the touch sensing stage, turning off the switching transistors, with first signals, to disconnect the first part and the second part of the common electrode comprises:
in the touch sensing stage, the gate scanning signals turn off the first to the last rows of gate lines, all gate lines output low levels, all of the switching transistors connected with the gate lines are turned off, and the first part and the second part of the common electrode are disconnected from each other.

9. The driving method of claim 7, wherein the switching transistors are thin film transistors.

10. The capacitive touch array substrate of any of claim 3, wherein the switching transistors are thin film transistors, source electrodes of the thin film transistors are connected with the touch driving leads, drain electrodes of the thin film transistors are connected with the common electrode leads, and gate electrodes of the thin film transistors are configured to input first signals.

11. The capacitive touch array substrate of claim 10, wherein the gate electrodes of the thin film transistors connected with one of the touch driving leads are connected with the gate lines in the region corresponding to this touch driving lead for the touch driving electrodes in one-to-one correspondence, and the first signals are signals received from the gate lines.
